(19) United States
(12) Patent Application Publication
(10) Pub. No.: US 2022/0403157 A1
(43) Pub. Date: Dec. 22, 2022

(54) POLYESTER COMPOSITION

(71) Applicant: Furanix Technologies B.V., Amsterdam (NL)

(72) Inventor: Francesco Acquasanta, Amsterdam (NL)

(21) Appl. No.: 17/773,648

(22) PCT Filed: Oct. 29, 2020
(86) PCT No.: PCT/EP2020/080356

§ 371 Date: May 2, 2022

(30) Foreign Application Priority Data
Nov. 5, 2019 (EP) 19207196.7

(51) Int. Cl. C08L 67/02

(52) U.S. Cl. CPC C08L 67/02; C08L 2205/08

(57) ABSTRACT

A polyester composition includes (a) poly(alkylene-2,5-furandicarboxylate); and (b) an oxygen scavenger composition including (b1) a polybutadiene sacrificial material; (b2) an oxidation catalyst; (b3) optionally, a carrier; and (b4) optionally, a compatibilizer.

### CROSS-REFERENCE TO RELATED APPLICATIONS

This application is the National Stage of International Application No. PCT/EP2020/080356, filed Oct. 29, 2020, which claims the benefit of European Application No. 19207196.7, filed Nov. 5, 2019, the contents of which is incorporated by reference herein.

### FIELD OF THE INVENTION

The present invention relates to a polyester composition comprising poly(alkylene-2,5-furandicarboxylate) (PEF) and an additive.

### BACKGROUND OF THE INVENTION

Poly(alkylene-2,5-furandicarboxylate) has been developed as a polyester with advantageous properties. Monomers which can be used are an alkylene glycol and 2,5-furandicarboxylic acid. 2,5-Furandicarboxylic acid (2,5-FDCA) is a diacid that can be produced from natural sources such as carbohydrates. Routes for its preparation use air oxidation of 2,5-disubstituted furans such as 5-hydroxymethylfurfural or ethers thereof with catalysts comprising Co and Mn. Such preparation methods have been disclosed in e.g. WO 2010/132740, WO 2011/043660 and WO 2011/043661.

WO 2013/062408 discloses high barrier properties of PEF in an oriented structure, such as a bottle, and respective uses of PEF for a packaging material. It is disclosed that the barrier properties of a PEF bottle are such that the rate of penetration of oxygen into the container is reduced by five-fold compared to a conventional PET container. This level of oxygen barrier may be sufficient to use the resin for packaging of oxygen sensitive materials such as fruit juices, vitamin waters, beer, and wine without relying on costly oxygen scavengers or multilayer film technology.

WO 2016/032330 is related to oriented films comprising poly(ethylene-2,5-furandicarboxylate). It is disclosed that the films may comprise one or more additives. A variety of additives is generically listed like e.g. plasticizers, softeners, dyes, antioxidants, oxygen scavengers, UV-stabilizers, fillers and other additives. No further details are given.

In US 2013/270295 it is mentioned that the benefits of PEF may be enhanced by blending various compounds that can scavenge various molecules, such as oxygen, moisture, etc. An example of such a compound is farnesene, which can be used to scavenge oxygen.

Oxygen scavengers and their use are generally known. S. Solovyov, Oxygen Scavengers in Kirk-Othmer Encyclopedia of Chemical Technology, 2014, John Wiley & Sons, p. 1-31 discusses inorganic scavengers, organic and polymer based scavengers and biochemical and biological systems. Embedded scavenger systems are described to be complex as these rely on interactions with the surrounding matrix for activation and scavenging function.

A wide variety of oxygen scavengers are known for use with PET. The examples of US 2013/0256323 show that polybutadienes reacted with methacrylate or p-aminobenzamide were more active than non-functionalized polybutadienes. It is taught that it is essential for oxygen scavenging that at least part of the compound comprising an allylic group and a polar moiety is not present in the continuous PET phase.

JP2011157411 teaches that yellowing in alkali-cleaning of PET resin containing oxygen absorbent is reduced by the use of 1,2-polybutadiene and 1,4 polybutadiene in combination with a transition metal compound wherein the amount of 1,2-polybutadiene is at least 50% wt with respect to the total amount of 1,2-polybutadiene and 1,4-polybutadiene.

When compared to PET, PEF exhibits improved barrier properties in packaging application. With an oxygen permeation rate that is ca. 10 times lower than that of PET, PEF is a suitable material for bottles or film laminates packaging containing oxygen sensitive products such as juices, nectars, or teas.

Nevertheless PEF's intrinsic barrier performance may not be sufficient for highly oxygen sensitive products such as beer, where oxygen quantities as high as 1 ppm can already spoil the organoleptic qualities of the beverage.

### SUMMARY OF THE INVENTION

The present invention is directed at a polyester composition comprising (a) poly(alkylene-2,5-furandicarboxylate); and (b) an oxygen scavenger composition comprising (b1) a polybutadiene sacrificial material; (b2) an oxidation catalyst; (b3) optionally, a carrier; and (b4) optionally, a compatibilizer. Furthermore, it is directed at a process for preparing such composition which process comprises mixing (a) poly(alkylene-2,5-furandicarboxylate); with (b) an oxygen scavenger composition comprising (b1) a polybutadiene sacrificial material; (b2) an oxidation catalyst; (b3) optionally, a carrier; and (b4) optionally, a compatibilizer. This process can further comprise extruding the mixture of poly(alkylene-2,5-furandicarboxylate) (a) and oxygen scavenger composition (b).

### DETAILED DESCRIPTION OF THE INVENTION

The poly(alkylene-2,5-furandicarboxylate) typically comprises 2,5-FDCA as diacid building block and an alkylene glycol, or a mixture of alkylene glycols, as diol building blocks. The alkylene glycol may be selected from the group consisting of C₂-C₁₀ alkylene glycol, suitably from the group consisting of C₂-C₆ alkylene glycols, more preferably from the group consisting of C₂-C₄ alkylene glycol. Most preferably, the alkylene glycol is ethylene glycol. The amount of alkylene glycol is suitably in the range of from 100 to 95 mol %, based on the molar amount of diacid building blocks. If the amount of alkylene glycol is less than 100 mol %, the remaining diol building blocks may comprise dialkylene glycol, such as diethylene glycol, trialkylene glycol, isosorbide, erythritol or mixtures thereof. Preferably, the amount of alkylene glycol of the poly(alkylene-2,5-furandicarboxylate) is 100% based on the molar amount of diacid building blocks. Suitably, the diacid building blocks of the polyester consists for at least 95 mol % of 2,5-FDCA. The remaining 5 mol % may comprise other diacids, such as terephthalic acid, isophthalic acid, azelaic acid, adipic acid, sebacic acid, succinic acid, 1,4-dicyclohexane dicarboxylic acid, maleic acid and mixtures thereof. The poly(alkylene 2,5-furandicarboxylate) suitably comprises only 2,5-FDCA as diacid building blocks. Since the diol preferably comprises ethylene glycol, the poly(alkylene-2,5-furandicarboxylate) preferably consists of poly(ethylene 2,5-furandicarboxylate). The poly(alkylene-2,5-furandicarboxylate) will typically have a glass transition temperature of from 80 to 85° C., which is the value for non-oriented poly(alkylene-2,5-furandicarboxylate).

The polyester composition typically comprises of from 70 to 99.9% by weight (% wt), of (a) poly(alkylene-2,5-furandicarboxylate) and of from 0.1 to 30% wt of (b) an oxygen scavenger composition wherein the oxygen scavenger composition. The oxygen scavenger composition typically comprises of from 0.1 to 9% wt of a polybutadiene sacrificial material (b1); of from 0.01 to 1% wt of an oxidation catalyst (b2); optionally, a carrier (b3); and optionally, a compatibilizer (b4) wherein the total amount of (b1), (b2), (b3) and (b4) is of from 0.1 to 30% wt. All % wt amounts are based on total amount of polyester composition consisting of poly(alkylene-2,5-furandicarboxylate) and oxygen scavenger composition consisting (b1), (b2), (b3) and (b4) in so far as (b3) and (b4) are present. The oxygen scavenger composition preferably consists of (b1), (b2), (b3) and (b4) in so far as (b3) and (b4) are present. If the carrier (b3) and/or the compatibilizer (b4) (partly) contain poly(alkylene-2,5-furandicarboxylate), this poly(alkylene-2,5-furandicarboxylate) is to be considered part of the poly(alkylene-2,5-furandicarboxylate) of component (a) for determining whether a polyester composition is according to the invention.

The polyester composition comprises preferably at least 90% wt and more preferably at least 93% wt of poly(alkylene-2,5-furandicarboxylate). Further compounds which can be present are compounds other than poly(alkylene-2,5-furandicarboxylate) and oxygen scavenger composition which aim to improve the properties of the polyester composition. The polyester composition preferably comprises at most 99.9% wt of poly(alkylene-2,5-furandicarboxylate).

Preferably, the polybutadiene sacrificial material is 1,3-polybutadiene.

The polyester composition typically comprises at least 0.1% wt of oxygen scavenger composition (b). Preferably, the total amount of (b1), (b2), (b3) and (b4) is at least 0.2% wt, more specifically at least 0.3% wt, more specifically at least 0.5% wt, more specifically at least 1% wt. A relatively large amount of oxygen scavenger can be required in case of a multilayer bottle or film laminate in which the PEF polyester composition is a minor part of the total structure but has to attribute a substantial part of the oxygen barrier properties. In most cases, the amount of an oxygen scavenger composition (b) preferably is at most 20% wt, more specifically at most 15% wt. Preferably, the total amount of (b1), (b2), (b3) and (b4) is at most 10% wt, more specifically at most 8% wt, more specifically at most 7% wt.

The amount of polybutadiene sacrificial material preferably is at least 0.5% wt, more specifically at least 1% wt. A relatively small amount of polybutadiene sacrificial material has the advantage that any possible negative effects on clarity are minimized. The amount of polybutadiene sacrificial material preferably is at most 8% wt, more specifically at most 7% wt, more specifically at most 6% wt, more specifically at most 5% wt.

Preferably, the oxidation catalyst (b2) comprises a metal or a metal salt of a transition metal which transition metal preferably is selected from cobalt, cupper, iron or mixtures thereof, more specifically cobalt and/or iron either as a metal or as a salt. Most preferably, the oxidation catalyst (b2) is cobalt either in the form of metal or as its salt. The amount of oxidation catalyst preferably is at least 0.05% wt, more specifically at least 0.1% wt, more specifically at least 0.2% wt, more specifically at least 0.5% wt. The amount of oxidation catalyst preferably is at most 5% wt, more specifically at most 3% wt, more specifically at most 2% wt.

The carrier (b3) can be present or absent. If present, the carrier preferably is a polymer matrix comprising a polymer selected from the group consisting of polyesters, polyolefin, ethylene/vinyl acetate copolymer, butyl rubber, styrene/butadiene rubber, styrene/butadiene/styrene block copolymers, isoprene, styrene/isoprene/styrene block copolymers styrene/ethylene/butylene/styrene block copolymers, and mixtures thereof. The carrier preferably is a polymeric matrix consisting of a polyester, epoxide, phenolic, polyurethane, polyvinyl chloride homopolymer, polyvinyl chloride copolymers and mixtures thereof. The most preferred carrier is polyester, more specifically poly(alkylene furandicarboxylates).

The compatibilizer (b4) can be present or absent. If present, the compatibilizer preferably is a compound having a polar moiety and a non-polar moiety and is present in amounts effective to uniformly disperse the oxygen scavenger composition in the polyester composition. The compatibilizer (b4) typically is a polymer having a non-polar polyolefin backbone and a grafted carboxylic acid group thereon forming the polar moiety, more specifically is a maleic anhydride grafted polyolefin such as a maleic anhydride grafted polyolefin including of from 0.2 to 2% wt of maleic anhydride.

A suitable oxygen scavenger composition is Amosorb which is commercially available from PolyOne. Amosorb is a trademark.

As indicated above, the poly(alkylene-2,5-furandicarboxylate) can contain C₂-C₁₀ alkylene groups, suitably C₂-C₆ alkylene groups, more preferably C₂-C₄ alkylene groups. Most preferably, the poly(alkylene-2,5-furandicarboxylate) is poly(ethylene 2,5-furandicarboxylate).

It has been found that the end groups of the polyester chains can have an influence on the effectiveness of the oxygen scavenger composition. The end groups can be selected from the group consisting of a carboxylic end group, a hydroxyl end group, a methyl ester end group and a furoic acid end group. The latter may be obtained owing to decarboxylation in the polymerization process. When the poly(alkylene-2,5-furandicarboxylate) is poly(ethylene 2,5-furandicarboxylate) it has been found advantageous that the poly(ethylene 2,5-furandicarboxylate) has a carboxylic end group content in the range of 0 to 122 meq/kg, preferably from 2 to 100 meq/kg. The carboxylic acid end groups are determined by using the titration method according to ASTM D7409, adapted for poly(ethylene 2,5-furan-dicarboxylate). A thus modified method thereof involves the titration of a 4% w/v solution of poly(ethylene 2,5-furandicarboxylate) in ortho-cresol with 0.01M KOH in ethanol as titrant to its equivalence point, using 0.5 mg of bromocresol green (2,6-dibromo-4-[7-(3,5-dibromo-4-hydroxy-2-methyl-phenyl)-9,9-dioxo-8-oxa-9λ6-thiabicyclo[4.3.0]nona-1,3,5-trien-7-yl]-3-methyl-phenol) in 0.1 ml ethanol as indicator. The poly(ethylene 2,5-furan-dicarboxylate) preferably has a carboxylic end group content in the range of 0 to 122 meq/kg.

In addition the polyethylene 2,5-furandicarboxylate can have a hydroxyl end group content in the range of 30 to 200 meq/kg and/or a furoic acid end group content in the range of 0 to 30 meq/kg, more specifically 0 to 15 meq/kg.

In general, there are a number of methods to determine the end groups in polyesters. Such methods include titration, infrared and nuclear magnetic resonance (NMR) methods. Often the separate methods are used to quantify the four main end groups: carboxylic acid end groups, hydroxyl end groups, alkyl ester groups, such as the methyl ester end groups (for polyesters from the dialkyl ester of a dicarboxylic acid) and the end groups that are obtained after decarboxylation. A. T Jackson and D. F. Robertson have published an ¹H-NMR method for end group determination in “Molecular Characterization and Analysis of Polymers” (J. M. Chalmers en R. J. Meier (eds.), Vol. 53 of “Comprehensive Analytical Chemistry”, by B. Barcelo (ed.), (2008) Elsevier, on pages 171-203. In this method the hydroxyl end group is determined in polyethylene terephthalate (PET) by using a selection of harsh solvents such as 3-chlorophenol, 1,1,1,3,3,3-hexafluoro-2-propanol, trichloroacetic acid or trifluoroacetic acid. It is preferred to use deuterated 1,1,2,2-tetrachloroethane (TCE-d2) as solvent without any derivatization of the polyester. A similar method can be carried out for polyesters that comprise furandicarboxylate moieties and ethylene glycol residues. The measurement of the end groups for the latter polyesters can be performed at room temperature without an undue risk of precipitation of the polyester from the solution. This ¹H-NMR method using TCE-d2 is very suitable to determine the hydroxyl end groups (HEG) and the furoic acid end groups, also known as decarboxylation end groups (DecarbEG). Peak assignments are set using the TCE peak at a chemical shift of 6.04 ppm. The furan peak at a chemical shift of 7.28 ppm is integrated and the integral is set at 2.000 for the two protons on the furan ring. The HEG is determined from the two methylene protons of the hydroxyl end group at 4.0 ppm. The content of DEG is determined from the integral of the shifts at 3.82 to 3.92 ppm, representing four protons. The decarboxylated end groups are found at a shift of 7.64-7.67 ppm, representing one proton. When the polyester also comprises methyl ester end groups, the methyl signal will occur at about 3.97 ppm, representing 3 protons.

The poly(ethylene 2,5-furandicarboxylate) may have a relatively high molecular weight. The molecular weight is expressed in terms of intrinsic viscosity. First the relative viscosity (ηᵣₑₗ) is determined in a 60/40 w/w mixture of phenol and tetrachloroethane at 30° C. and a concentration (c) of 0.4 g/dL. This procedure is similar to the ASTM D4603 standard for the determination of the inherent viscosity for poly(ethylene terephthalate). The intrinsic viscosity is then calculated using the Billmyer equation:

Intrinsic viscosity(IV)={ηᵣₑₗ−1+3*ln(ηᵣₑₗ)}/(4*c)

The poly(ethylene 2,5-furandicarboxylate) preferably has a molecular weight expressed as intrinsic viscosity (IV) of at least 0.60 dL/g, preferably of at least 0.75 dL/g. The IV preferably is at most 1.2 dL/g.

The poly(ethylene 2,5-furandicarboxylate) has typically been subjected to solid state polymerization, also known as solid stating. Due to the solid state polymerization, the molecular weight can be increased such as to 0.65 to 1.2 dL/g, preferably to an intrinsic viscosity of at least 0.75 dL/g, more preferably in the range of 0.75 dL/g to 1.2 dL/g.

The polyester compositions can be used in a variety of applications.

Typically, the compositions can be used in packaging. The compositions can be used in combination with other materials in order to improve the mechanical properties and/or reduce costs. Combining can be achieved by using the polyester composition in a multilayer system or by blending. The current polyester compositions is suitable for rigid containers such as preforms, injection molded articles, thermoformed articles and compression molded articles each of which subsequently can have been blown. Especially preferred rigid containers are bottles and coffee capsules. The current polyester compositions also are suitable for flexible packaging material such as extruded sheets and oriented and non-oriented films. The polyester composition is especially suitable for use in articles for packaging oxygen sensitive materials, beverages and/or food. An especially preferred application are bottles comprising polyester composition according to the invention. Another especially preferred application are sheets comprising polyester composition according to the invention. It will be clear that this is a non-exhaustive list of possible applications for the current polyester compositions.

The present disclosure may be modified and practiced in different but equivalent manners apparent to those skilled in the art having the benefit of the teachings herein. Whenever a numerical range with a lower limit and an upper limit is disclosed, any number and any included range falling within the range is specifically disclosed.

The invention is further illustrated by means of the following examples.

### Examples

The following components were used:

The PEF resin is a poly(ethylene-2,5-furandicarboxylate) has a Mw of 104,000 (as determined by GPC based on polymethylmetacrylate standards).

Amosorb is an active barrier (oxygen scavenger composition) commercially available from PolyOne containing an oxidation catalyst and polybutadiene as sacrificial material.

Valspar ValOR 135J is an active barrier (oxygen scavenger composition) containing an oxidation catalyst and polyamide as sacrificial material.

Invista Polyshield MB F031 is an active barrier (oxygen scavenger composition) containing an oxidation catalyst and requiring the addition of polyamide as sacrificial material. We separately added polyamide MXD6 (Mitsubishi S6007).

The PEF resin and the oxygen scavenger composition were milled independently. The resin was vacuum dried at 150° C. overnight. The dry powders were dry blended and extruded using a Haake MiniCTW in continuous mode at 260° C. (PEF based blends). The extruded materials were immediately grinded and stored in oxygen and water-free atmosphere.

The extruded materials shown in Table 1 were then used to compression mold ˜100 μm thick films, 12 cm in diameter, by using a hot press (245° C.). The films were immediately cooled to room temperature and stored in an atmosphere substantially free from oxygen and water.

Oxygen permeation measurements were carried out using permeation cells equipped with PreSens oxygen sensors and PreSens Fibox measurement equipment. The procedure used was as follows. The film thickness was measured on several points. The cell was assembled and both chambers were purged with N₂ (O₂ residue 70-200 ppm). During a period of 5 to 7 days the measured O₂ content values were noted every day for a more accurate measurement of the zero value of the cell. The bottom cell was purged with humidified compressed air. The O₂ content was measured for a predetermined period of time, e.g. 20-30 days, or until an increase in oxygen ingress rate could be observed.

TABLE 1
Oxygen transmission rates and permeability

| Sample | | 1 | 2 | 3 | 4 | 5 |
|---|---|---|---|---|---|---|
| PEF | [% wt] | 100 | 95 | 80 | 75 | 95 |
| Amosorb | [% wt] | | | | | 5 |
| Valspar ValOR 135J | [% wt] | | 5 | | | |
| Invista Polyshield MB F031 | [% wt] | | | 20 | 20 | |
| MXD6 Mitsubishi Nylon S6007 | [% wt] | | | | 5 | |
| Average thicknes of the film | [μm] | 85 | 86 | 90 | 94 | 87 |
| Permeability | cc · mm/(m2 · 24 h · bar) | 0.18 | 0.19 | 0.41 | 0.43 | n.a. |
| Scavenger active | Yes/No | No | No | No | No | Yes |
| Duration scavenger activity | days | n.a. | n.a. | n.a. | n.a. | ~100 |
| Permeability for the first 6-8 | cc · mm/(m2 · 24 h · bar) | 0.17 | 0.15 | 0.39 | 0.41 | <0.05* |
| days | | | | | | |
| Permeability after the first 6-8 | cc · mm/(m2 · 24 h · bar) | 0.19 | 0.19 | 0.42 | 0.44 | 0.13** |
| days | | | | | | |

*for the first 80 days
**after day 120

It will be clear from comparing the performance of sample 5 according to the invention with the performance of comparative samples 1 to 4 that a polybutadiene sacrificial agent decreases the oxygen permeability of PEF based films effectively for a substantial amount of time.

1. A polyester composition comprising:
(a) poly(alkylene-2,5-furandicarboxylate); and
(b) an oxygen scavenger composition comprising
(b1) a polybutadiene sacrificial material;
(b2) an oxidation catalyst;
(b3) optionally, a carrier; and
(b4) optionally, a compatibilizer.

2. The composition according to claim 1 wherein the polyester composition comprises of from 70 to 99.9% wt of (a) poly(alkylene-2,5-furandicarboxylate) and of from 0.1 to 30% wt of (b) an oxygen scavenger composition.

3. The composition according to claim 2 wherein the oxygen scavenger composition (b) comprises of from 0.1 to 9% wt of a polybutadiene sacrificial material (b1); of from 0.01 to 1% wt of an oxidation catalyst (b2); optionally, a carrier (b3); and optionally, a compatibilizer (b4) wherein the total amount of (b1), (b2), (b3) and (b4) is of from 0.1 to 30% wt.

4. The composition according to claim 1, wherein the poly(alkylene-2,5-furandicarboxylate) is poly(ethylene 2,5-furandicarboxylate).

5. The composition according to claim 4, wherein the poly(ethylene 2,5-furan-dicarboxylate) has a carboxylic end group content in the range of from 0 to 122 meq/kg.

6. The composition according to claim 4, wherein the poly(ethylene 2,5-furandicarboxylate) has a hydroxyl end group content in the range of 30 to 200 meq/kg and/or a furoic acid end group content in the range of 0 to 15 meq/kg.

7. A process for preparing a composition according to claim 1 which process comprises mixing (a) poly(alkylene-2,5-furandicarboxylate); with (b) an oxygen scavenger composition comprising (b1) a polybutadiene sacrificial material; (b2) an oxidation catalyst; (b3) optionally, a carrier; and (b4) optionally, a compatibilizer.

8. The process according to claim 7, which process further comprises extruding the mixture of poly(alkylene-2,5-furandicarboxylate) (a) and oxygen scavenger composition (b).

9. A rigid container comprising polyester composition according to claim 1.

10. A flexible packaging material comprising polyester composition according to claim 1.
